(19) United States
(12) Patent Application Publication
(10) Pub. No.: US 2024/0237658 A1
(43) Pub. Date: Jul. 18, 2024

(54) METHOD AND SYSTEM FOR CONTAMINATION INTERVENTION

(71) Applicant: Cargill, Incorporated, Wayzata, MN (US)

(72) Inventor: Tyson Brown, Godley, TX (US)

(73) Assignee: Cargill, Incorporated, Wayzata, MN (US)

(21) Appl. No.: 18/559,735

(22) PCT Filed: May 12, 2022
(86) PCT No.: PCT/US2022/028990

§ 371 Date: Nov. 8, 2023

Related U.S. Application Data
(60) Provisional application No. 63/187,694, filed on May 12, 2021.

(51) Int. Cl. A22B 5/00; A22B 5/16

(52) U.S. Cl. CPC A22B 5/0082; A22B 5/161

(57) ABSTRACT

Intervention of contamination of an exposed carcass meat surface during processing of an animal carcass comprises providing a flexible sheet having first and second major surfaces comprising an antimicrobial agent on the first major surface of the flexible sheet, wherein the flexible sheet is food-contact safe; detaching a portion of hide from the carcass, thereby providing an exposed carcass meat surface; and placing the flexible sheet on the exposed carcass meat surface so that the antimicrobial agent contacts the exposed carcass meat surface. The flexible sheet is also described.

### CROSS-REFERENCE TO RELATED APPLICATIONS

This application claims the benefit of U.S. Provisional Patent Application No. 63/187,694, filed 12 May 2021, which is hereby incorporated by reference in its entirety.

### FIELD

The present application relates to methods, systems, and devices for contamination intervention in the processing of animal carcasses.

### BACKGROUND

Sanitation and general food safely is a high priority in the harvesting process of animals. Various techniques of cleaning animal carcasses have been developed, such as the cleaning unit having a pair of oscillating spray bar assemblies as described in U.S. Pat. No. 4,337,549 to Anderson.

U.S. Pat. No. RE36645 to Davis describes an apparatus and method for removing a hide from a back portion of a carcass. Davis explains that in a slaughterhouse processing line, the hide is commonly removed from a carcass by a downpuller that grips a previously detached portion of the hide and pulls downwardly thereon forcibly pulling the hide from the carcass. In preparation for removal of the hide by the downpuller, the hide may be detached from various portions of the carcass by cutting the hide along the underside of the carcass to provide side flaps; pulling the side flaps around the sides of the carcass leaving the hide attached to the back portions of the carcass; and removing the hide from the tail and back portions so that the hide remains attached only to the head and shoulder region and, perhaps, the front legs of the carcass. A downwardly hanging portion of the hide is thereby provided for the downpuller to grip and pull. Davis describes sterilizing various components of the apparatus by subjecting the parts to heat treatment, disinfectant spraying, steaming or other appropriate disinfection method, but does not discuss treatment steps on the carcass itself.

U.S. Pat. No. 6,394,889 to O'Neill describes a method and apparatus for aseptically separating and removing the hide of an animal from its carcass wherein the hide is separated from the carcass prior to marking of the hide using at least one cutting implement inserted between the hide and the carcass for cutting the connecting tissue attaching the hide and carcass. The hide, once separated, is then marked and removed from the carcass. As explained in O'Neill, during commercial processing of aminals (cattle, sheep, swine, etc.) for meat, the animal's hide is conventionally removed from its carcass by apparatus such as a downpulling assembly or downpuller. Typically, the animal, after being sacrificed, is suspended by the hocks of its hind legs from a conveyor and transported to the downpuller. The downpuller grips a previously detached portion of the hide and pulls downwardly thereon forcibly pulling the hide from the animal's carcass. In order to aseptically separating and removing the hide of an animal from its carcass, O'Neill describes use of a cutting implement that is inserted between the hide and the carcass for cutting the connective tissue attaching the hide and carcass. This facilitates removal of the hide from the carcass, substantially without significant stretching or pulling. O'Neill states that the possibility of transferring contaminants from the hide to the carcass is reduced, and that the likelihood that the hide may be damaged during removal is also lessened. O'Neill describes application of a sterilizing or disinfecting agent to the hide by a low pressure spray, brushing, high pressure spraying, pouring, etc., as is shown in O'Neill FIG. 2.

### SUMMARY

During commercial processing of animals (cattle, sheep, swine, etc.) for meat, the animal's hide is conventionally removed from its carcass, exposing meat surfaces to potential contamination by microorganisms, such as bacteria and fungi, and non-microorganism contaminants. Additionally, the meat surfaces are also exposed to potential contamination by particulates or other materials that should not be present in meat. Contamination of these exposed surfaces can take place at any point in the meat processing procedure, such as when production worker touches the surface when positioning the carcass for a given operation or urging the carcass to the next station in the process. Additional potential contamination points include contact of the carcass with a rail or barrier, or contact of the carcass with another carcass being processed. In an aspect, one of the stages of commercial meat processing of high concern of potential contamination of exposed meat surfaces is at the operational stage of hide removal, where freshly exposed carcass meat surfaces are in close proximity to the hide as it is being removed, or where the worker detaching a portion of the hide from the carcass may inadvertently contact the hide and the carcass, or the hide itself may inadvertently contact the exposed carcass meat surface.

It has been found that even though washing exposed carcass meat surfaces with an antibacterial wash solution can help reduce contamination of meat surfaces, superior intervention of contamination can be achieved by use of a flexible sheet having first and second major surfaces comprising an antimicrobial agent on the first major surface of the flexible sheet in direct contact with the exposed carcass meat surface. The present method thus both treats exposed carcass meat surfaces with an antibacterial material and acts to assist in prevention of contamination during the process by acting as a physical barrier to prevent access of microorganisms and non-microorganism contaminants to the exposed carcass meat surface.

In an aspect, the present method additionally advantage places flexible sheets that act as a physical barrier to prevent access of microorganisms and non-microorganism contaminants to the exposed carcass meat surface on portions of the carcass, thereby providing “safe landing” zones for workers to contact the carcass without fear of contamination of the carcass at the point of contact. This facilitates faster processing of the carcasses in the production facility, because workers can use the “safe landing” zone for contacting the carcass as necessary for performing processing operations, including steadying the carcass from movement, urging the carcass in position such as pushing the carcass to the next station in a production line, or as a contact point for supporting or leveraging tools used to carry out certain tasks. Likewise, the flexible sheets can provide “safe landing” zones for other contact surfaces, such as rails or even other carcasses on the production line, to contact the carcass without fear of contamination of the carcass at the point of contact. The present method has been found to be particularly advantageous in the context of commercial processing of animal carcasses, and most particularly for commercial processing in large scale production facilities. It has been found that the use of the present method can enhance the speed of carcass handling due to the features as described herein.

In an aspect, a method of intervention of contamination of an exposed carcass meat surface during processing of an animal carcass comprises providing a flexible sheet having first and second major surfaces comprising an antimicrobial agent on the first major surface of the flexible sheet, wherein the flexible sheet is food-contact safe. A portion of hide is detached from the carcass, thereby providing an exposed carcass meat surface, and the flexible sheet is placed on the exposed carcass meat surface so that the antimicrobial agent contacts the exposed carcass meat surface.

In an aspect, a method of removing a hide from an animal carcass comprises providing a flexible sheet having first and second major surfaces comprising an antimicrobial agent on the first major surface of the flexible sheet, wherein the flexible sheet is food-contact safe. A portion of the hide is detached from the carcass to provide a hide flap to be gripped by a mechanical hide gripper and an exposed carcass meat surface corresponding at least in part to the hide flap, and the flexible sheet is placed on the exposed carcass meat surface so that the antimicrobial agent contacts the exposed carcass meat surface.

In an aspect, a flexible sheet for application to a meat surface is provided wherein the flexible sheet has first and second major surfaces comprising an antimicrobial agent on the first major surface of the flexible sheet, wherein the flexible sheet is food-contact safe.

In an aspect, a flexible sheet for application to a meat surface is provided wherein the flexible sheet has first and second major surfaces comprising an antimicrobial agent on the first major surface and the second major surface of the flexible sheet, wherein the flexible sheet is food-contact safe. The aspect where the antimicrobial agent is on both major surfaces is particularly beneficial, because the flexible sheet can be quickly applied to the exposed carcass meat surface without concern that the correct side is being applied to the meat surface. Additionally, the aspect where the antimicrobial agent is on both major surfaces is beneficial when the sheet is used as a “safe landing” zone for contacting the carcass by workers or other contact surfaces as discussed above, because the contact with any such contact surface acts to treat that surface with an antimicrobial treatment. This added treatment beneficially enhances the overall cleanliness and sanitation of the production facility as a whole.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a side elevational view of a flexible sheet on an exposed carcass meat surface after partially detaching a portion of hide from the legs of a carcass in preparation hide removal by a mechanical hide removal apparatus.

FIG. 2 is a partial cross-sectional side view of a flexible sheet on an exposed carcass meat surface after partially detaching a portion of hide from a carcass.

FIG. 3 is a partial cross-sectional side view of a flexible sheet on an exposed carcass meat surface after the hide has been removed.

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

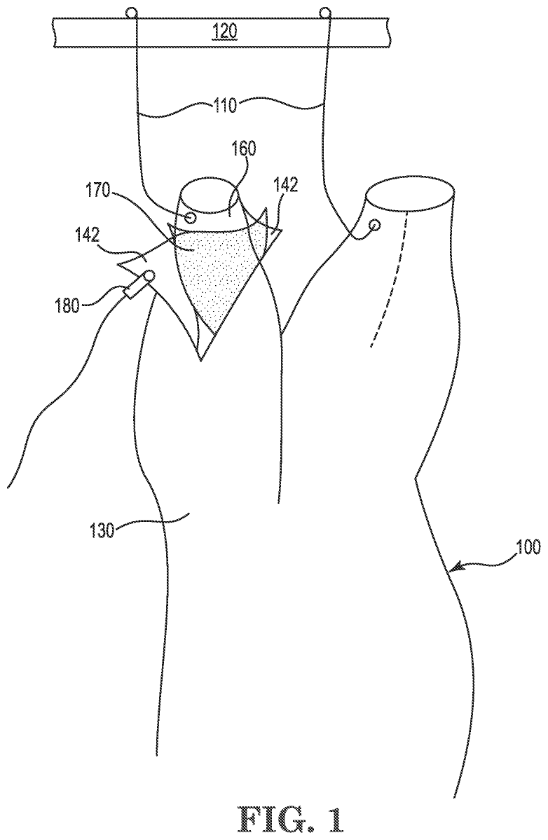

As noted above, one of the stages of commercial meat processing of high concern of potential contamination of exposed meat surfaces is at the operational stage of hide removal. FIG. 1 is a side elevational view of a carcass at the early steps of hide removal. As shown, animal carcass 100 is suspended by its hind legs on trolleys or hooks 110 for transport through the processing plant via a rail conveyor system 120. For instance, hooks 110 may be inserted through the Achilles tendon of the hocks of the animal's hind legs.

In preparation for removal of the animal's hide 130 from carcass 100, the hide is at least partially detached and pulled away from the carcass to provide hide flaps 140 and 142 to be gripped by a mechanical hide gripper 180 to facilitate complete removal of hide 130. The step of detaching a portion of the hide from the carcass to provide a hide flap establishes an exposed carcass meat surface 160 that corresponds at least in part to the hide flap. The detaching of hide may be accomplished by cutting or otherwise separating a portion of the hide from the carcass using, for example, a cutting implement such as a blade, a rotary saw, a laser, or apparatus for emitting a stream of matter under pressure.

The exposed carcass meat surface 160 is particularly vulnerable to contamination by microorganism and non-microorganism contaminants at the stage where the hide is at least partially detached and pulled away from the carcass to provide hide flaps.

A flexible sheet 170 having first and second major surfaces comprising an antimicrobial agent on the first major surface of the flexible sheet is placed on the exposed carcass meat surface 160 so that the antimicrobial agent contacts the exposed carcass meat surface.

In a commercial scale operation, the hide is then typically removed by including the step of cutting the hide along the longitudinal axis of the carcass on the underside from the throat area to the crotch area, and removing the edges of the hide from the fascia to form additional side flaps. These side flaps can be gripped by side hide gripping devices and, in an optional first step, a portion of the hide is removed from the underside of the carcass by applying a side pulling force by one or more side-puller devices. Simultaneously or as a subsequent step, additional flaps may be formed by cutting the hide in the throat area and/or the crotch area generally perpendicular to the longitudinal axis of the carcass and removing the edges of the hide from the fascia to form top and/or bottom flaps. These form top and/or bottom flaps that can be gripped by hide gripping devices and a portion or the remainder of the hide is removed from the carcass by applying a downward or upward pulling force using one or more down-puller or up-puller devices.

In an aspect, flexible sheets may be applied to the exposed carcass at the location of these additional flaps.

In an aspect, the flaps of loosened hide are gripped by a hide gripping device that is operably connected to one or more mechanical hide pulling apparatus. The hide gripping device may be provided in any configuration suitable for grasping the hide, such as clamp or a chain having a slip loop. In an aspect, the hide gripping device comprises jaws that grip the hide by a force applied, for example by a spring, a set of compression cylinders, or a gear or mechanical linkage driven by an electric motor, air compressor, hydraulic system or other force causing one or more jaws to engage the hide. The hide gripping device may be actuated by any appropriate control device, such as a mechanical control or an electrical control as will now be understood by the artisan.

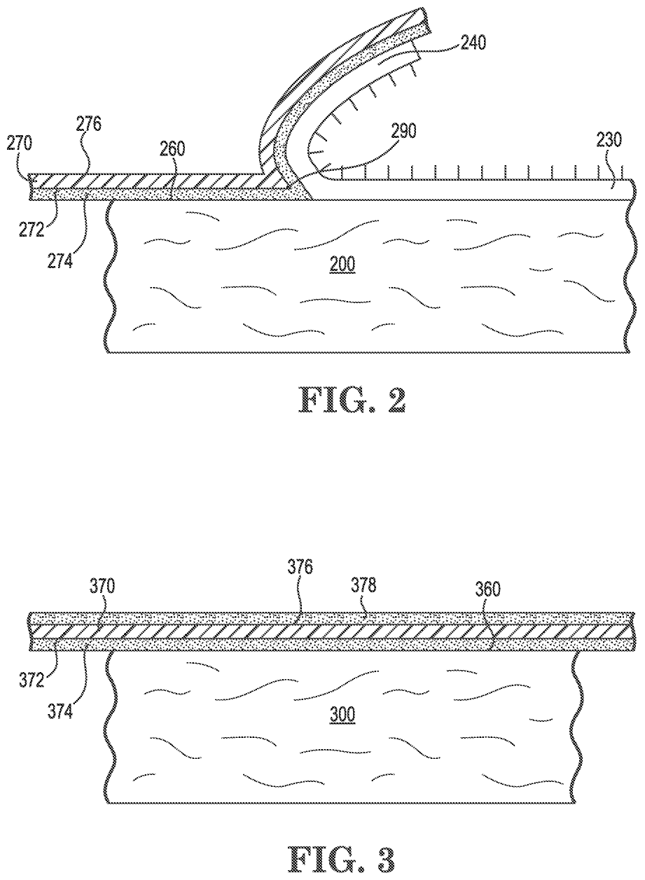

FIG. 2 is a partial cross-sectional side view of a flexible sheet 270 on an exposed carcass meat surface 260 after partially detaching a portion of hide 230 from carcass 200. As shown, flexible sheet 270 is applied to both the exposed carcass meat surface 260 and flap 240 of hide 230, and is urged into the connective region 290 where flap 240 of hide 230 is still joined with carcass 200. In an aspect, flexible sheet 270 may be applied only to the exposed carcass meat surface 260, and is not applied to flap 240 of hide 230.

Flexible sheet 270 has first major surface 272 and second major surface 276. Antimicrobial agent 274 is provided on first major surface 272 of flexible sheet 270.

During processing, a worker may in an aspect cut hide 230 to detach a portion of the hide from the carcass to provide flap 240 and apply flexible sheet 270 to at least a portion of the resulting exposed carcass meat surface 260. The worker can then use second major surface 276 of flexible sheet 270 as a contact surface, for example, for steadying the carcass and/or the flap while securing a mechanical hide gripper on the flap.

FIG. 3 is a partial cross-sectional side view of a flexible sheet 370 on an exposed carcass meat surface 360 after the hide has been completely removed from carcass 300. As shown, antimicrobial agent 374 is provided on first major surface 372 of flexible sheet 370, and antimicrobial agent 378 is provided on second major surface 376 of flexible sheet 370.

As noted above, the flexible antimicrobial sheet is food-contact safe. For purposes of the present discussion a material is food-contact safe if it is free of any toxic contaminants which could be contacted from the manufacturing process and will not potentially become a source of toxic contamination through usage). Ultimate determination of whether a material is food-contact safe is made under applicable regulations of the relevant government entities.

In an aspect, the flexible sheet is a physical barrier to transfer of microorganisms and non-microorganism contaminants therethrough. In an aspect, the flexible sheet does not permit penetration of bacteria or particles having a size of 50 microns. In an aspect, the flexible sheet does not permit penetration of bacteria or particles having a size of 0.002 microns.

In an aspect, the flexible sheet comprises a fiber-based substrate, such as paper. In an aspect, the flexible sheet is made from a pulp-material such as rice straw, hemp or bamboo. In an aspect, the flexible sheet is rice paper.

In an aspect, the flexible sheet comprises paper having a weight of from about 30 g m² to about 45 g/m². In an aspect, the flexible sheet comprises paper having a weight of from about 35 g/m² to about 40 g/m². In an aspect, the flexible sheet comprises paper having a weight of from about 46 g/m² to about 100 g/m². In an aspect, the flexible sheet comprises paper having a weight of from about 50 g/m² to about 70 g/m².

In an aspect, the flexible sheet comprises a polymeric layer. In an aspect, the flexible sheet comprises a polymeric layer made from a material selected from Ethylene vinyl alcohol (EVOH), Polyvinylidene dichloride (PVDC), Poly (vinyl alcohol) (PVOH), nylon, polyimide, polyester, polyacrylonitrile, low density polyethylene, copolymers thereof, or a combination thereof.

In an aspect, the flexible sheet comprises a polymeric layer having a thickness of from about 0.2 mils to 3 mils, or from 0.4 mils to 2.5 mils, or from 1.8 mils to 2.2 mils, or from 1.4 mils to 1.6 mils, or from 0.9 mils to 1.1 mils, or from 0.7 mils to 0.9 mils, or from 0.4 mils to 0.6 mils.

In an aspect, the flexible sheet is sufficiently flexible that it conforms to contours of the exposed carcass meat surface without significant gaps between the flexible sheet and the surface of the exposed carcass meat, so that provides a high degree of contact between the respective surfaces, leading to surface adhesion to the exposed carcass meat surface. This surface adhesion causes the flexible sheet to remain in place on the exposed carcass meat surface during relevant steps or operations in processing of the animal carcass. In an aspect, the flexible sheet is sufficiently flexible that a 5 cm×5 cm strip will conform to a meat surface comprising a 5 cm long channel with a 1 cm radius without separation for 5 minutes.

In an aspect, the flexible sheet is formed from a material that has a Gurley stiffness of 500 or less in milligrams (mg) force in each of its machine direction and transverse direction. In an aspect, the flexible sheet is formed from a material that has a Gurley stiffness of 400 or less in milligrams (mg) force in each of its machine direction and transverse direction. In an aspect, the flexible sheet is formed from a material that has a Gurley stiffness of 300 or less in milligrams (mg) force in each of its machine direction and transverse direction. In an aspect, the flexible sheet is formed from a material that has a Gurley stiffness of 200 or less in milligrams (mg) force in each of its machine direction and transverse direction. In an aspect, the flexible sheet is formed from a material that has a Gurley stiffness of 100 or less in milligrams (mg) force in each of its machine direction and transverse direction.

For purposes of the present disclosure, Gurley Stiffness is determined the test method set forth in ASTM D 6125-97. A suitable testing apparatus is a Gurley Digital Stiffness Tester: Model 4171DS1N manufactured by Teledyne Gurley (514 Fulton Street, Troy, N.Y. 12181-0088).

In an aspect, the flexible sheet is provided in a roll that can be cut or torn to size at an operation station of an animal carcass processing line. In an aspect, the flexible sheet is provided in a roll having width of from about 10 cm to 90 cm. In an aspect, the flexible sheet is provided in a roll having width of from about 20 cm to 90 cm. In an aspect, the flexible sheet is provided in a roll having width of from about 30 cm to 90 cm. In an aspect, the flexible sheet is provided in a roll having width of from about 10 cm to 45 cm. In an aspect, the flexible sheet is provided in a roll having width of from about 20 cm to 45 cm. In an aspect, the flexible sheet is provided in a roll having width of from about 30 cm to 45 cm. In an aspect, the flexible sheet is provided in sheet size of from about 20×20 cm to about 90×90 cm. In an aspect, the flexible sheet is provided in sheet size of from about 30×30 cm to about 90×90 cm. In an aspect, the flexible sheet is provided in sheet size of from about 40×40 cm to about 90×90 cm. In an aspect, the flexible sheet is provided in sheet size of from about 20×20 cm to about 45×45 cm. In an aspect, the flexible sheet is provided in sheet size of from about 30×30 cm to about 45×45 cm. In an aspect, the flexible sheet is provided in sheet having a shape selected from square, rectangular, triangular, polygonal, circular, and elliptical. In an aspect, the flexible sheet is provided in a custom shape to cover a portion of the exposed carcass meat surface as beneficial to carry out a specified operation in the processing of an animal carcass.

In an aspect, the flexible sheet is provided in a color that is not normally present in an animal processing environment. The selection of a color that stands out in contrast from colors that are otherwise normally is present assists in identification of “safe landing” zones on the carcass provided by the flexible sheet, and also in identifying the flexible sheet as a foreign material to be removed from the meat if it inadvertently is not removed when no longer needed in the work flow of processing of the animal carcass. In an aspect, the flexible sheet is provided in a color other than red, white, beige, light grey, brown or stainless steel color. In an aspect, the flexible sheet is provided in a color selected from green and blue.

In an aspect, the antimicrobial agent is selected from any antimicrobial material safe and suitable for contact with meat. In an aspect, the antimicrobial agent is selected from an antimicrobial material identified as being safe and suitable under the US Department of Agriculture Food Safety and Inspection Service Directive 7120.1 as revised from time to time for use in antimicrobial intervention systems. In an aspect, the antimicrobial agent comprises a compound selected from the group consisting of sodium carbonate, disodium metasilicate, potassium hydroxide, sodium hypochlorite, sodium hydroxide, sodium gluconate, sodium tripolyphosphate, sodium hypochlorite, peroxyacetic acid (PAA), hydrogen peroxide (HP), acetic acid, 1-hydroxethylidine-1,1-disphonic acid (HEDP), dipicolinic acid (DPA), sulfuric acid, hypobromous acid, peracetic acid, lactic acid, and mixtures thereof.

In an aspect, the antimicrobial agent is present on the flexible sheet as a dry coating. Because the exposed carcass meat surface is naturally at least somewhat moist, the dry antimicrobial agent is at least partially hydrated and transferred to the meat surface, thereby providing an antimicrobial effect on the meat surface.

In an aspect, the antimicrobial agent is present on the flexible sheet as a component of a pressure-sensitive adhesive coating. Providing the antimicrobial agent in at least a somewhat tacky layer is beneficial in that the antimicrobial is in a more mobile state, and can be more readily transferred to the meat surface, thereby providing an antimicrobial effect on the meat surface. Additionally, when the antimicrobial agent in at least a somewhat tacky layer, the flexible sheet may be more adherent to the exposed carcass meat surface, reducing the probability that the sheet will inadvertently fall off of the carcass during processing operations. In an aspect, the antimicrobial agent is present on a major surface of the flexible sheet as a component of a pressure-sensitive adhesive coating, and the major surface is provided with a non-coated portion to assist in handling of the flexible sheet. In an aspect, the antimicrobial agent is present on a major surface of the flexible sheet as a component of a pressure-sensitive adhesive coating, and the major surface is provided with a release liner on at least a portion of the adhesive coating to assist in handling of the flexible sheet. In an aspect, flexible sheets comprise antimicrobial agent present as a component of a pressure-sensitive adhesive coating on the first major surface of the sheet, and a low adhesion coating on the second major surface of the sheet. In an aspect, these flexible sheets are provided as a pad of sheets adhered to each other in a stack.

In an aspect, the antimicrobial agent is present on the flexible sheet in a coating having no gaps greater than 1 mm². In an aspect, the antimicrobial agent is present on the flexible sheet as a continuous coating, meaning there are no gaps in coverage of the antimicrobial agent on the surface of the sheet.

In an aspect, the antimicrobial agent is applied to a surface of the flexible sheet as a component of a continuous coating comprising binder and optional additional ingredients suitable for use in a food-contact safe coating, such as filler and colorant. In an aspect, the antimicrobial agent is applied to a surface of the flexible sheet as a component of a continuous coating at a coating weight of from 3 g/m² to 30 g/m². In an aspect, the antimicrobial agent is applied to a surface of the flexible sheet as a component of a continuous coating at a coating weight of from 5 g/m² to 25 g/m². In an aspect, the antimicrobial agent is applied to a surface of the flexible sheet as a component of a continuous coating at a coating weight of from 5 g/m² to 20 g/m². In an aspect, the antimicrobial agent is applied to a surface of the flexible sheet as a component of a continuous coating at a coating weight of from 5 g/m² to 15 g/m².

In an aspect, the antimicrobial agent is applied to a first major surface of the flexible sheet. In an aspect, the antimicrobial agent is applied to the first major surface and the second major surface of the flexible sheet.

The antimicrobial agent as described herein can be applied to a flexible sheet by any suitable known coating technique, such as, for example, air knife coating, rod coating, bar coating, wire bar coating, spray coating, brush coating, cast coating, flexible blade coating, gravure coating, jet applicator coating, extrusion coating, short dwell coating, slide hopper coating, curtain coating, flexographic coating, size-press coating, gate roll coating, reverse roll coating and transfer roll coating. In an aspect, the antimicrobial agent is applied as a single coat to a major surface of the flexible sheet. In an aspect, the antimicrobial agent is applied a plurality of times to a major surface of the flexible sheet. In an aspect, the antimicrobial agent is applied as a single coat to both sides (i.e. both major surfaces) of the flexible sheet. In an aspect, the antimicrobial agent is applied a plurality of times to both sides (i.e. both major surfaces) of the flexible sheet.

The present method in an aspect is advantageous in the production of red meat slaughter animals (i.e., an animal that is slaughtered for red meat consumption), including without limitation all age and classes of bovine, porcine, and ovine animals. Bovine animals include cattle, steers, heifers, cows, bulls, and also buffalo. Porcine animals include sows, gilts, barrows, boars, and feeder pigs. Ovine animals include sheep and lamb. In an aspect, the present method may also apply to the production of tenderized meat from other animals as well, such as poultry or fish. In an aspect, the present method is particularly advantageous in the production of beef products.

As noted above, the present method has been found to be particularly advantageous in the context of commercial processing of animal carcasses, and most particularly for commercial processing in large scale production facilities. In an aspect, the processing of an animal carcass is performed at speeds that equal the chain speed of the processing line, referred to herein as “commercial chain speeds.” In an aspect, the processing of an animal carcass is performed at a production rate of from about 150 to about 600 head of cattle per hour. In an aspect, the processing of an animal carcass is performed in an animal processing facility at a production rate of from about 200 to about 600 head of cattle per hour. In an aspect, the processing of an animal carcass is performed at a production rate of from about 250 to about 600 head of cattle per hour.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios. For example, “about” can mean greater or lesser than the value or range of values stated by 1/10 of the stated values, but is not intended to limit any value or range of values to only this broader definition. For instance, a concentration value of about 30% means a concentration between 27% and 33%. Each value or range of values preceded by the term “about” is also intended to encompass the embodiment of the stated absolute value or range of values. Alternatively, particularly with respect to biological systems or processes, the term can mean within an order of magnitude, preferably within 5-fold, and more preferably within 2-fold, of a value.

Throughout this specification and claims, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein “consisting of” excludes any element, step, or ingredient not specified in the claim element. When used herein, “consisting essentially of” does not exclude materials or steps that do not materially affect the basic and novel characteristics of the claim. In the present disclosure of various embodiments, any of the terms “comprising”, “consisting essentially of” and “consisting of” used in the description of an embodiment may be replaced with either of the other two terms.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

### EXAMPLES

The following examples are non-limiting examples of the invention described herein.

Example 1. A method of intervention of contamination of an exposed carcass meat surface during processing of an animal carcass, comprising: providing a flexible sheet having first and second major surfaces comprising an antimicrobial agent on the first major surface of the flexible sheet, wherein the flexible sheet is food-contact safe; detaching a portion of hide from the carcass, thereby providing an exposed carcass meat surface; and placing the flexible sheet on the exposed carcass meat surface so that the antimicrobial agent contacts the exposed carcass meat surface.

Example 2. A method for removing a hide from an animal carcass, comprising: providing a flexible sheet having first and second major surfaces comprising an antimicrobial agent on the first major surface of the flexible sheet, wherein the flexible sheet is food-contact safe; detaching a portion of the hide from the carcass to provide a hide flap to be gripped by a mechanical hide gripper, and an exposed carcass meat surface corresponding at least in part to the hide flap; and placing the flexible sheet on the exposed carcass meat surface so that the antimicrobial agent contacts the exposed carcass meat surface.

Example 3. The method of example 2, further comprising completely removing the hide from the carcass.

Example 4. The method of any one of examples 1-3, wherein the flexible sheet is applied to the exposed carcass meat surface on a portion of the carcass to provide a safe landing zone for contacting the carcass during processing of the animal carcass.

Example 5. The method of any one of examples 1-4, wherein the flexible sheet comprises an antimicrobial agent on the first and second major surfaces thereof.

Example 6. The method of any one of examples 1-5, wherein the flexible sheet comprises a fiber-based substrate; or wherein the comprises paper having a weight of from about 30 g/m2 to about 45 g/m2.

Example 7. The method of any one of examples 1-5, wherein the flexible sheet comprises a polymeric layer; or wherein the flexible sheet comprises a polymeric layer made from a material selected from Ethylene vinyl alcohol (EVOH), Polyvinylidene dichloride (PVDC), Poly (vinyl alcohol) (PVOH), nylon, polyimide, polyester, polyacrylonitrile, low density polyethylene, copolymers thereof, or a combination thereof; or wherein the flexible sheet comprises a polymeric layer having a thickness of from about 0.2 mils to 3 mils.

Example 8. The method of any one of examples 1-7, wherein the flexible antimicrobial sheet has a Gurley stiffness of 500 or less in milligrams (mg) force in each of its machine direction and transverse direction; or wherein the flexible sheet is formed from a material that has a Gurley stiffness of 400 or less in milligrams (mg) force in each of its machine direction and transverse direction; or wherein the flexible sheet is formed from a material that has a Gurley stiffness of 300 or less in milligrams (mg) force in each of its machine direction and transverse direction; or wherein the flexible sheet is formed from a material that has a Gurley stiffness of 200 or less in milligrams (mg) force in each of its machine direction and transverse direction; or wherein the flexible sheet is formed from a material that has a Gurley stiffness of 100 or less in milligrams (mg) force in each of its machine direction and transverse direction.

Example 9. The method of any one of examples 1-8, wherein the antimicrobial agent is present as a dry coating.

Example 10. The method of any one of examples 1-8, wherein the antimicrobial agent is applied to a surface of the flexible sheet as a component of a continuous coating comprising binder and optional additional ingredients suitable for use in a food-contact safe coating; or wherein the antimicrobial agent is present on the flexible sheet as a component of a pressure-sensitive adhesive coating.

Example 11. The method of any one of examples 1-10, wherein the antimicrobial agent is applied to a surface of the flexible sheet as a component of a continuous coating at a coating weight of from 3 g/m2 to 30 g/m2, or wherein the antimicrobial agent is applied to a surface of the flexible sheet as a component of a continuous coating at a coating weight of from 5 g/m2 to 25 g/m2, or wherein the antimicrobial agent is applied to a surface of the flexible sheet as a component of a continuous coating at a coating weight of from 5 g/m2 to 20 g/m2, or wherein the antimicrobial agent is applied to a surface of the flexible sheet as a component of a continuous coating at a coating weight of from 5 g/m2 to 15 g/m2.

Example 12. The method of any one of examples 1-11, wherein the antimicrobial agent is selected from the group consisting of sodium carbonate, disodium metasilicate, potassium hydroxide, sodium hypochlorite, sodium hydroxide, sodium gluconate, sodium tripolyphosphate, sodium hypochlorite, peroxyacetic acid (PAA), hydrogen peroxide (HP), acetic acid, 1-hydroxethylidine-1,1-disphonic acid (HEDP), dipicolinic acid (DPA), sulfuric acid, hypobromous acid, peracetic acid, lactic acid, and mixtures thereof.

Example 13. The method of any one of examples 1-12, wherein the flexible antimicrobial sheet is provided in a color that is not normally present in an animal processing environment.

Example 14. The method of any one of examples 1-13, wherein the processing of an animal carcass is performed in an animal processing facility at a production rate of from about 150 to about 600 head of cattle per hour.

Example 15. A flexible antimicrobial sheet for application to a meat surface comprising: a flexible sheet having first and second major surfaces comprising an antimicrobial agent on the first major surface of the flexible sheet, wherein the flexible sheet is food-contact safe.

Example 16. The flexible antimicrobial sheet of example 15, wherein the flexible sheet comprises an antimicrobial agent on the first and second major surfaces thereof.

Example 17. The flexible antimicrobial sheet of example 15 or 16, wherein the flexible sheet comprises a fiber-based substrate; or wherein the comprises paper having a weight of from about 30 g/m2 to about 45 g/m2.

Example 18. The flexible antimicrobial sheet of example 15 or 16, wherein the flexible sheet comprises a polymeric layer; or wherein the flexible sheet comprises a polymeric layer made from a material selected from Ethylene vinyl alcohol (EVOH), Polyvinylidene dichloride (PVDC), Poly (vinyl alcohol) (PVOH), nylon, polyimide, polyester, polyacrylonitrile, low density polyethylene, copolymers thereof, or a combination thereof; or wherein the flexible sheet comprises a polymeric layer having a thickness of from about 0.2 mils to 3 mils.

Example 19. The flexible antimicrobial sheet of any one of examples 15-18, wherein the flexible antimicrobial sheet has a Gurley stiffness of 500 or less in milligrams (mg) force in each of its machine direction and transverse direction; or wherein the flexible sheet is formed from a material that has a Gurley stiffness of 400 or less in milligrams (mg) force in each of its machine direction and transverse direction; or wherein the flexible sheet is formed from a material that has a Gurley stiffness of 300 or less in milligrams (mg) force in each of its machine direction and transverse direction; or wherein the flexible sheet is formed from a material that has a Gurley stiffness of 200 or less in milligrams (mg) force in each of its machine direction and transverse direction; or wherein the flexible sheet is formed from a material that has a Gurley stiffness of 100 or less in milligrams (mg) force in each of its machine direction and transverse direction.

Example 20. The flexible antimicrobial sheet of any one of examples 15-19, wherein the antimicrobial agent is present as a dry coating.

Example 21. The flexible antimicrobial sheet of any one of examples 15-19, wherein the antimicrobial agent is applied to a surface of the flexible sheet as a component of a continuous coating comprising binder and optional additional ingredients suitable for use in a food-contact safe coating; or wherein the antimicrobial agent is present on the flexible sheet as a component of a pressure-sensitive adhesive coating.

Example 22. The flexible antimicrobial sheet of any one of examples 15-19, wherein the antimicrobial agent is applied to a surface of the flexible sheet as a component of a continuous coating at a coating weight of from 3 g/m2 to 30 g/m2, or wherein the antimicrobial agent is applied to a surface of the flexible sheet as a component of a continuous coating at a coating weight of from 5 g/m2 to 25 g/m2, or wherein the antimicrobial agent is applied to a surface of the flexible sheet as a component of a continuous coating at a coating weight of from 5 g/m2 to 20 g/m2, or wherein the antimicrobial agent is applied to a surface of the flexible sheet as a component of a continuous coating at a coating weight of from 5 g/m2 to 15 g/m2.

Example 23. The flexible antimicrobial sheet of any one of examples 15-22, wherein the antimicrobial agent is selected from the group consisting of sodium carbonate, disodium metasilicate, potassium hydroxide, sodium hypochlorite, sodium hydroxide, sodium gluconate, sodium tripolyphosphate, sodium hypochlorite, peroxyacetic acid (PAA), hydrogen peroxide (HP), acetic acid, 1-hydroxethylidine-1,1-disphonic acid (HEDP), dipicolinic acid (DPA), sulfuric acid, hypobromous acid, peracetic acid, lactic acid, and mixtures thereof.

Example 24. The flexible antimicrobial sheet of any one of examples 15-23, wherein the flexible antimicrobial sheet is provided in a color that is not normally present in the animal processing environment.

1. A method of intervention of contamination of an exposed carcass meat surface during processing of an animal carcass, comprising:
providing a flexible sheet having first and second major surfaces comprising an antimicrobial agent on the first major surface of the flexible sheet, wherein the flexible sheet is food-contact safe;
detaching a portion of hide from the carcass, thereby providing an exposed carcass meat surface; and
placing the flexible sheet on the exposed carcass meat surface so that the antimicrobial agent contacts the exposed carcass meat surface.

2. A method for removing a hide from an animal carcass, comprising:
providing a flexible sheet having first and second major surfaces comprising an antimicrobial agent on the first major surface of the flexible sheet, wherein the flexible sheet is food-contact safe;
detaching a portion of the hide from the carcass to provide a hide flap to be gripped by a mechanical hide gripper, and an exposed carcass meat surface corresponding at least in part to the hide flap; and
placing the flexible sheet on the exposed carcass meat surface so that the antimicrobial agent contacts the exposed carcass meat surface.

3. The method of claim 2, further comprising completely removing the hide from the carcass.

4. The method of claim 14, wherein the flexible sheet is applied to the exposed carcass meat surface on a portion of the carcass to provide a safe landing zone for contacting the carcass during processing of the animal carcass.

5. The method of claim 1, wherein the flexible sheet comprises an antimicrobial agent on the first and second major surfaces thereof.

6. The method of claim 1, wherein the flexible sheet comprises a fiber-based substrate; or wherein the comprises paper having a weight of from about 30 g/m² to about 45 g/m².

7. The method of claim 1, wherein the flexible sheet comprises a polymeric layer.

8. The method of claim 1, wherein the flexible antimicrobial sheet has a Gurley stiffness of 500 or less in milligrams (mg) force in each of its machine direction and transverse direction.

9. The method of claim 1, wherein the antimicrobial agent is present as a dry coating.

10. The method of claim 1, wherein the antimicrobial agent is applied to a surface of the flexible sheet as a component of a continuous coating.

11. The method of claim 1, wherein the antimicrobial agent is applied to a surface of the flexible sheet as a component of a continuous coating at a coating weight of from 3 g/m² to 30 g/m².

12. The method of claim 1, wherein the antimicrobial agent is selected from the group consisting of sodium carbonate, disodium metasilicate, potassium hydroxide, sodium hypochlorite, sodium hydroxide, sodium gluconate, sodium tripolyphosphate, sodium hypochlorite, peroxyacetic acid (PAA), hydrogen peroxide (HP), acetic acid, 1-hydroxethylidine-1,1-disphonic acid (HEDP), dipicolinic acid (DPA), sulfuric acid, hypobromous acid, peracetic acid, lactic acid, and mixtures thereof.

13. The method of claim 1, wherein the flexible antimicrobial sheet is provided in a color that is not normally present in an animal processing environment.

14. The method of claim 1, wherein the processing of an animal carcass is performed in an animal processing facility at a production rate of from about 150 to about 600 head of cattle per hour.

15. A flexible antimicrobial sheet for application to a meat surface comprising:
a flexible sheet having first and second major surfaces comprising an antimicrobial agent on the first major surface of the flexible sheet, wherein the flexible sheet is food-contact safe.

16. The flexible antimicrobial sheet of claim 15, wherein the antimicrobial agent is applied to a surface of the flexible sheet as a component of a continuous coating comprising binder and optional additional ingredients suitable for use in a food-contact safe coating; or wherein the antimicrobial agent is present on the flexible sheet as a component of a pressure-sensitive adhesive coating.

17. The flexible antimicrobial sheet of claim 15, wherein the antimicrobial agent is selected from the group consisting of sodium carbonate, disodium metasilicate, potassium hydroxide, sodium hypochlorite, sodium hydroxide, sodium gluconate, sodium tripolyphosphate, sodium hypochlorite, peroxyacetic acid (PAA), hydrogen peroxide (HP), acetic acid, 1-hydroxethylidine-1,1-disphonic acid (HEDP), dipicolinic acid (DPA), sulfuric acid, hypobromous acid, peracetic acid, lactic acid, and mixtures thereof.

18. The method of claim 1, wherein the antimicrobial agent is present on the flexible sheet as a component of a pressure-sensitive adhesive coating.
